(19) United States
(12) Patent Application Publication
(10) Pub. No.: US 2025/0222478 A1
(43) Pub. Date: Jul. 10, 2025

(54) GROUND DEPOSITION MACHINE TANK MANAGEMENT SYSTEM

(71) Applicant: Micropply Limited, Altrincham, Cheshire (GB)

(72) Inventors: Anthony David George Rhoades, Hale, Altrincham (GB); Samuel Paul Cornish-Evans, Knutsford, Cheshire (GB); Lewis Cassidy, Stretford, Manchester (GB); Jiri Dohnalek, Warrington (GB)

(21) Appl. No.: 18/853,190

(22) PCT Filed: Apr. 12, 2023
(86) PCT No.: PCT/GB2023/050986

§ 371 Date: Oct. 1, 2024

(30) Foreign Application Priority Data
Apr. 12, 2022 (GB) 2205392.0

(51) Int. Cl. B05B 12/08; A01C 23/04; A01M 7/00; A01M 9/00; B05B 13/00

(52) U.S. Cl. CPC B05B 12/081; A01M 7/0089; A01M 9/0092; B05B 13/005; A01C 23/04

(57) ABSTRACT

A tank management system for an autonomous ground marking robot, the tank management system comprising: an input operable to receive sensor data from one or more sensors coupled to at least one receptacle, the receptacle operable to hold a deposition material; a processor for processing said sensor data to obtain user diagnostics; an output for outputting said user diagnostics. Thus, providing the ability to communicate real-time consumption data of deposition materials from the tank management system to a monitoring cloud database. Which then the data for forecasting demand, forecasting refill rates, forecasting automated refilling schedule intervals, remote robot or complete system performance diagnostics using ‘over the air’ methods. Eliminating the need for the operator to act removes the possibility for human error. The method may also include gathering performance diagnostics of the autonomous robot.

The present invention relates to a ground marking Autonomous Deposition Robot (ADR) of a type equipped to deposit materials such as an ink and paint, but may equally deposit sand, seed, fertiliser, or other ground treatments onto a ground surface or for injection under pressure into a ground surface. Specifically, the present invention relates to a tank management system for an ADR.

Ground marking is typically carried out manually. It requires significant pre-planning, the manufacture of pre-ordered plastic stencils, and large teams of workers to decipher instructions, prepare, lay out, and complete a site for marking. Where marking is required such as for logos, safety or hazard signs, the complex make-up of these images mean that difficulties persist to print any image, any size, any colour, directly onto any ground surface without significant cost of time, expense and compromise in image attributes such as resolution.

One approach to automating ground marking is found in US 2005/0055142 A1 in which a turf image marker comprises a ground maintenance vehicle adapted to both mow and store grass as well as carry a marking device that includes a delivery system for applying a marking material to the ground. Dispensing devices for putting down marking materials are provided in the form of boxes requiring mechanisms that require to be driven such as a motor, electric, air or other fluid motor.

Another approach to automating ground marking is found in US 2005/0055142 A1 in which a turf image marker comprises a ground maintenance vehicle adapted to both mow and store grass as well as carry a marking device that includes a delivery system for applying a marking material to the ground. Dispensing devices for putting down marking materials are provided in the form of boxes, requiring mechanisms that require to be driven such as a motor, electric, air or other fluid motor.

### SUMMARY OF INVENTION

According to a first aspect of the present invention, there is provided a tank management system for an autonomous ground marking robot, the tank management system comprising: an input operable to receive sensor data from one or more sensors coupled to at least one receptacle, the receptacle operable to hold a deposition material; a processor for processing said sensor data to obtain user diagnostics; an output for outputting said user diagnostics.

Preferably, wherein the sensor is a temperature sensor, or the sensor is a weight measuring plate, or the sensor is a PIR sensor, or the sensor is an RFID reader. Preferably wherein the coupling is wired, or wireless.

Further preferably the system further comprises processing said sensor data to obtain system diagnostics, and outputting said system diagnostics. Wherein the user diagnostics may be tamper data. Further, wherein the sensor data may be used for forecasting demand, forecasting refill rates, forecasting automated refilling schedule intervals, remote robot and/or complete system performance.

According to a second aspect of the present invention, there is provided an autonomous ground marking robot comprising: at least one receptacle to hold a deposition material; at least one deposition arrangement; a locomotion arrangement; and a tank management system according to the first aspect.

Preferably wherein the flexible bag or the tank is supported by a weight monitoring device or volume monitoring system. Further, the robot comprising one or more load sensors provided to measure the weight of the flexible bag, or flexible bag and tank.

Further preferably, wherein the robot comprises an accelerometer to measure tilt and computation means are provided to determine weight of the flexible bag or flexible bag and tank using one or more load sensors measurements whilst accounting for tilt.

Preferably, wherein the robot comprises an on-board control system, the onboard control system having a communications link to the weight monitoring device, wherein, when the robot is in use and depositing material on the ground, the onboard control system may be configured to periodically gather weight data from the weight monitoring device.

Further preferably, wherein the onboard control system is configured to transmit weight data to a remote resource, such as a cloud server, or an edge device optionally a tablet or smartphone.

Preferably, wherein the material for deposition is a herbicide, pesticide, insecticide, plant growth aid, water or marking material, optionally wherein the marking material is a paint, ink, coloured material, powder.

According to a third aspect of the present invention, there is provided a method of depositing material using a robot of the second aspect, the method comprising: a user sending deposition instructions to the autonomous robot; and the autonomous robot depositing material according to the deposition instructions.

According to a fourth aspect of the present invention, there is provided a method of calculating the usage weight of a tank of deposition material when in use in an autonomous deposition robot, the method comprising the steps of: obtaining initial tank weight data; obtaining tank and machine deposition flow rate data values for the tank and autonomous deposition robot; receiving at least one instruction for a deposition; carrying out the deposition in accordance with the at least one instruction; calculating the weight used in the deposition using the deposition flow rate data values; calculating the total weight of deposition material used by adding the weight used in the deposition to the current total weight usage; outputting the total weight of deposition material used; and estimating the new current weight of the tank based on the newly calculated total weight used from the tank subtracted from the initial weight.

According to a fifth aspect of the present invention, there is provided a tank management system for an autonomous ground marking robot, the tank management system operable to carry out the method steps of the fourth aspect.

Thus, allowing for the monitoring of the weight of the material for deposition in the flexible bag. This may alert users of the robot or system, or the supplier, when the material for deposition is running low. If a supplier is alerted, they could then supply the user with further material for deposition or ask them to authorise purchase of further material. Weight monitoring may be used to determine weight and volume.

A weight monitoring device and data collection allows the system to alert the user that there is not sufficient material for deposition for the instructions given to the robot. For example, prior to operation, the weight monitoring device can check if there is sufficient ink or paint or fertiliser or other deposition material to print a logo, or if there is sufficient fertiliser to cover the area instructed to be fertilised. The user can be informed prior to carrying out the instructions or job, so that the job is not started and not completed.

The use of weight monitoring also provides security function, where if the wrong weight of the bag is recorded, then the system, user or supplier may be alerted, possibly via a remote resource, such as a cloud server, or an edge device. This will prevent users from topping up the bags with unauthorised material, which may not work with the system or result in a loss of income for the supplier. For example, the primary packing or flexible bag may have a photodiode or a RFID tag which is linked to a specific weight. When the bag or smart tank is placed in the robot the sensor may check the photodiode or a RFID tag and the weight monitoring may check the weight of the bag or primary packaging, and if the weight and the photodiode or a RFID tag do not match the credentials of the supplier or owner of the robot, this could mean that some devices have been altered or tampered with and/or the robot may not work or function. Or, the instructions to the robot for a specific function, i.e. printing or fertilised deposition, may have weight of the material for deposition linked to the instructions, and the weight monitoring device can check if the weight is correct, for example not over a maximum threshold. These functions would prevent unauthorised material being used with the robot, providing advantages to a supplier or owner of the robot who has rented or leased the robot out for use.

The weight monitoring device and the sensor that determine the presence or absence of the flexible bag or the smart tank and/or the photodiode or a RFID tag of can be part of the same device, sensor or system.

Preferably, the robot is connected to a cloud system. Connection to a cloud system allows the user to achieve functionality anywhere, for example over the air fault diagnostics, real-time print management, vast secure storage and the means to operate robots anywhere in the operator's network. Use of a cloud system allows the collection of data which can aid in machine learning functionality, improve robot diagnostics, data aggregation and secure communication links between the edge, the cloud and all data processing devices as required. Use of a cloud-based system is built around the user to achieve functionality anywhere, over the air fault diagnostics, real-time print management, vast secure storage and the means to operate robotic printers anywhere in the operator's network.

Accordingly, there is provided a ground marking autonomous robot that in addition to high accuracy and throughput marking provides for robot diagnostics, data aggregation and secure communication links between the edge, the cloud and all data processing devices as required.

The ground marking autonomous robot is combined with artificial intelligence, machine learning, and an end-to-end Cloud SAAS (Software As A Service) platform that work together to create ground-printed images approaching the accuracy of a blade of grass, all underpinned with an advanced user-interface.

### LIST OF FIGURES

Embodiments of the invention will now be described by way of example only and with reference to the accompanying drawings, in which:

FIG. 1 is a schematic diagram of an ADR comprising an array of smart tank comprising bags filled with a ground marking material in accordance with one embodiment of the present invention;

FIG. 2 is a schematic diagram of smart tank comprising a flexible ink bag with a hose connected to a nozzle array in accordance with one embodiment of the present invention;

FIGS. 3a and 3b are plan views of a ground marking robot in accordance with one embodiment of the present invention;

FIG. 4 is a side elevation of a ground marking robot in accordance with one embodiment of the present invention;

FIG. 5 is a plan view of a ground marking operation in progress, in this embodiment tiled printing of a logo;

FIG. 6 is a schematic diagram of a smart communications module as used in the robot of FIGS. 1 to 5; and

FIG. 7 is a schematic diagram of a secure communications network between the robot, the edge, the cloud and a data processing device as used in the robot of FIGS. 1 to 5;

FIGS. 8a, 8b, 8c and 8d is a series of Paint Tank Error Graphs, as produced by the Tank Management System of the present invention;

FIGS. 9a & 9b is a diagram showing a method for accurate tank management, according to a second embodiment of the present invention; and

FIG. 10 is a process diagram showing the registration process of a smart tank, according to one embodiment of the present invention.

### DETAILED DESCRIPTION

The present techniques will be described more fully hereinafter with reference to the accompanying drawings. Like numbers refer to like elements throughout.

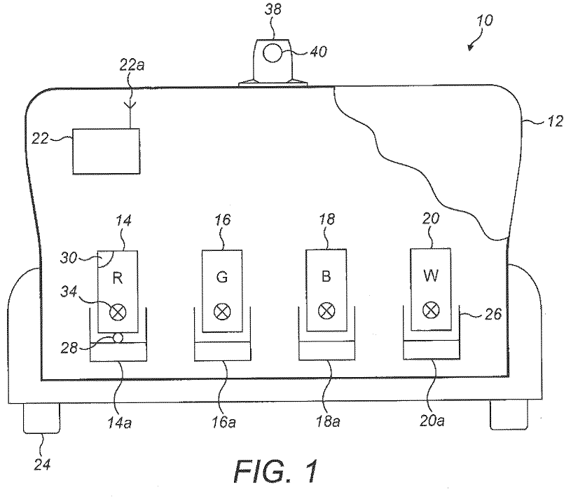

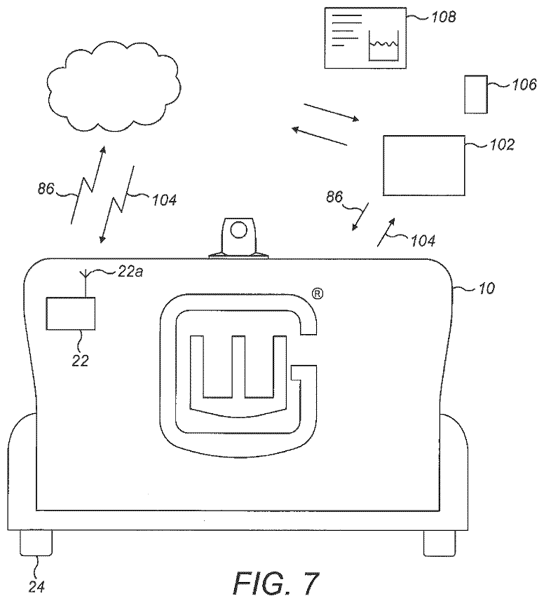

Referring to FIG. 1 a schematic diagram of an autonomous ground marking robot 10 comprises an outer case 12 cut away to reveal an array of smart tank 14, 16, 18 and 20. The smart tank 14, 16, 18 and 20 shown here comprises ink held within a bag (not shown in FIG. 1), with smart tank 14 comprising a red ink R, a green ink G, a blue ink B and a white ink W. Each smart tank 14, 16, 18 and 20 is supported on a weight measuring plate 14a, 16a, 18a and 20a connected to a smart communications module 22 described more fully in FIG. 6, which may also serve as or be connected to an on-board control system (not shown in FIG. 1). The smart communications module 22 comprises a transceiver 22a for communication with remote resources (not shown in FIG. 1).

Each weight measuring plate 14a, 16a, 18a and 20a is an integral part of a frame 26 capable of holding the smart tank 14, 16, 18, 20 firmly in place and comprises a load sensor 28 for registering the presence of the smart tank 14, 16, 18, 20 when firmly in place in the frame 26. Load sensor 28 may be a photodiode or a RFID tag that communicates with an ID tag 30 of the smart tank 14, 16, 18, 20. ID tag 30 may also comprise a barcode or other smart label, which is used for identification of the smart tank 14, 16, 18, 20.

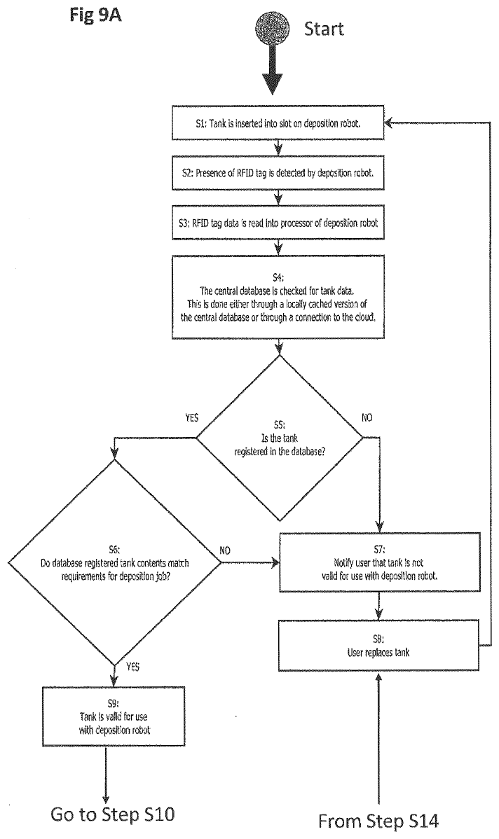

More than one load sensor 28 can be used for load balancing. For example, two, three, four or more load sensors can be positioned as part of or under a platform or frame (which may, for example, be the weight measuring plate 14a) supporting the ink bag and primary packaging. In operation, when the platform is flat then all the load sensors should measure the same normal force to each load sensor 28 i.e. the force in line with their mounting and perpendicular to the flat surface or platform supporting the ink bag and primary packaging. When the robot is on an incline then the platform is on an incline and so the load of the ink in the ink bag is not distributed evenly across the platform and the load sensors will show different readings. As gravity acts perpendicular to a 0° incline any deviation from this horizontal must be accounted for in any measurements. The robot determines it is at an angle or incline from an onboard accelerometer and can report any incline in 3-axes. To account for the incline, trigonometry can be used to convert the normal force the scale measures into the weight. This calculation can be done with the 3-axis vector (incline in 3-axes) extracted from the accelerometer. Therefore, the method includes reading an output of load sensors and applying a corrective formula and adjusting weight measurement to take into account the incline and determine an accurate weight and/or volume. This calculation is then used by the tank management system as described in further detail with reference to FIG. 8 following.

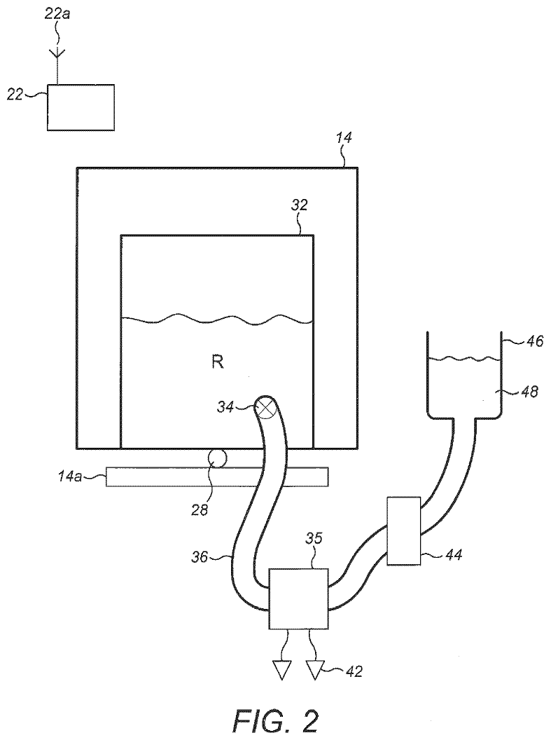

As best seen in FIG. 2, a flexible ink bag 32 comprises an airtight valve outlet 34 sealed to the flexible ink bag 32 with the appropriate connection part for secure connection to a hose 36. The hose 36 may also be a tube, piping or any suitable means to transport the material for deposition.

The robot 10 comprises wheels 24 for movement, a position sensor 38 and laser 40. Position sensor 38 may comprises a Global Positioning Device for navigation or the robot may use triangulation with known positioning reflectors and the laser 40 for positioning. In operation, the robot may be in constant communication with a positioning device and may reposition itself based on communication from a Global Positioning Device.

Turning to FIG. 2, the smart tank 14 comprising the flexible ink bag 32 with the hose 36 is connected to a nozzle array 42 via an actuator pump 35. Here the nozzle array 42 acts as the means to deposit the material for deposition. Any such suitable nozzle, nozzle array or means to deposit the material, depending on the actual material to be deposited, may be used. Each ink bag of the smart tank 14, 16, 18 and 20 of FIG. 1 will have a hose 36 and valve 34 to connect to the nozzle array 42 via the actuator pump 35. The system may have a single actuator pump 35 for all primary packaging/ink bag/hose (14,16,18,20/32/36), or there may be multiple actuator pumps, i.e. one for each smart tank/ink bags/hose (14,16,18,20/32/36). Each nozzle of the nozzle array 42 may be designated for each smart tank/ink bag/hose (14,16,18,20/32/36) present, so that each nozzle is for deposition of only the material held in each smart tank/ink bag (14,16,18,20/32).

In operation, the nozzle array 42 can deposit materials from each smart tank/ink bag (14,16,18,20/32) individually, or multiple nozzles of an array 42 can operate to blend materials together, e.g. colours of inks or paints, to deposit at the same time. The bags 32 may contain different colours of marking materials, i.e. inks or paints, which may comprise CYM or, if good black is required, CYMK colours. Since the substrate or ground to have these deposited upon will not likely be white, a white may be required for any print that has white or a paler shade than the colours contained in the bags 32. When depositing ink or paint to print an image, the image may be printed in sweeps to generate small adjacent dots (i.e. each dot comes from a single nozzle of the array 42), and when viewed from above or a suitable distance from afar (e.g. from the stand in a stadium or from a television view) appear to blend into colours, depending on the relative colours of the different inks or colours deposited.

The flexible ink bag 32 comprises the red ink R suitable for depositing a red colour on a ground yet the flexible ink bag 32 may comprise any material for deposition, for example a marking material or a chemical to deposit on the ground, such as a herbicide, pesticide, insecticide, paint, ink, coloured material, powder, fertilizer, plant growth aid or water, or the like provided that a compatible hose 36 and nozzle arrays 42 are attached.

When printing an image, the flexible ink bags 32 will usually contain sufficient material to be able to print an entire image without changing during the printing run of the robot. However, if required, an ink bag can be changed during the deposition cycle.

The hose 36 is connected to a manifold 44 connected to a tank 46 containing chemical liquids 48 which serve a variety of purposes. The chemical liquids 48 may be used to flush the hose 36 and nozzles 42.

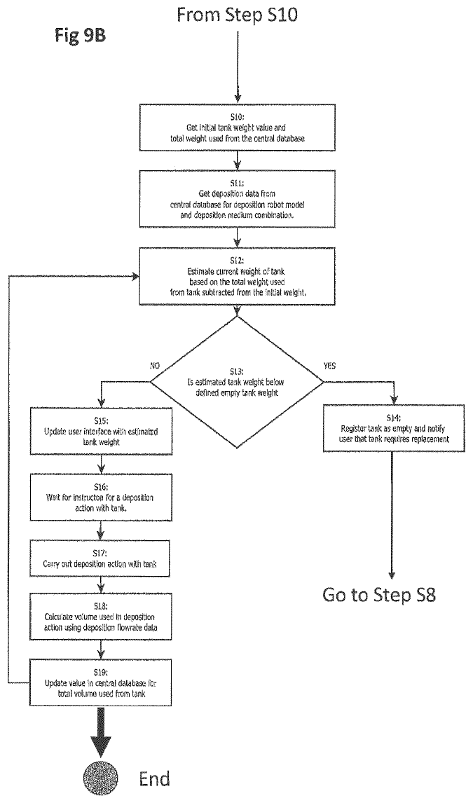

In operation, a user receives a package containing smart tank 14 as a lightweight, substantially rigid cardboard box containing therein a flexible bag 32 filled with a ground marking material, for example a red ink R. The user may register the marking material using the ID tag 30 to match marking materials held in a database by way of communication with module 22, as shall be further described with reference to FIG. 9.

In embodiments, the user may insert the smart tank 14 into a frame 26 of the robot 10. Alternatively, if the arrangement allows, then the user may remove the ink bag 32 from the smart tank 14 and place the ink bag into the frame 26. The sensor 28 may register the presence of the smart tank 14 and further verify that the correct ink bag 32 is located in the correct frame and may further undertake a verified check of the authenticity of the ink bag 32 using RFID technology or measurement from the weight monitoring plate 14a, as shall be further described with reference to FIG. 9.

During printing or ground marking the weight of the ink bag 32 will decrease as ink is deposited onto the ground. The weight monitoring plate 14a can measure the change in weight and gather data. How this data is then used by the tank management system of the present invention is further described with reference to FIG. 8 following.

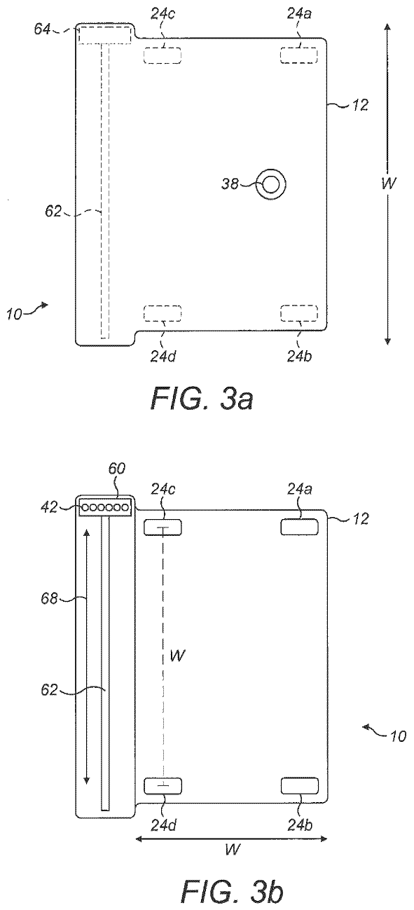

The hose 36 is attached to the valve 34 and with appropriate setting up of the robot as best described in FIGS. 3a, 3b, 4 and 5, printing or marking can commence.

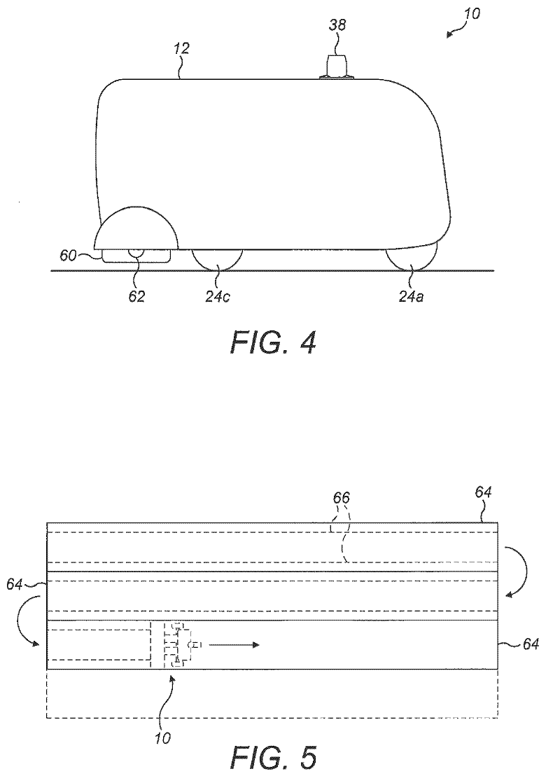

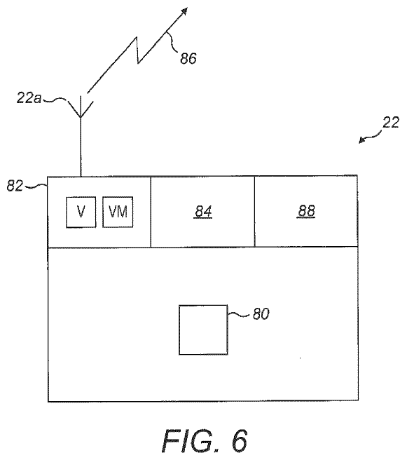

FIGS. 3a and 3b are plan views of the robot 10, 3a is a top view, 3b is an underneath view, FIG. 4 is a side elevation and FIG. 5 is a plan view of a ground marking operation in progress, in this embodiment tiled printing of a logo.

The ground printer 10 comprises the case 12 held securely by a chassis supporting the ground wheel arrangement 24 with a print head 60 on a traverse guide 62, the traverse guide 62 permitting movement of the print head 60 beyond the width W of the ground wheel arrangement 24, along the length of the print width 68. The nozzle array 42 as described above may be attached to the print head 60. The nozzles maybe fixed and the print head 60 moveable. The print head 60, via the print guide 62, may be moveable along the length of a print width 68, which is the area the print head is capable of printing. The print head 60 many also be movable vertically based on the image to be printed, for example the print head 60 can be moved up and down depending on the density of the image to be printed. The printhead can have a means (not shown) to monitor the ground height and adjust the printhead height accordingly, allowing for more accurate image printing or material deposition.

The ground wheel arrangement 24 comprises wheels 24a, 24b, 24c and 24d to steer the robot 10 along a path to affect the printing, and this may be under the control of a print file that can be loaded into the on-board control system such as may be contained communications module 22. The traverse guide 62 is fixed in relation to the ground wheel arrangement 24, so that it prints one line of an image along the print width 68. The ground wheel arrangement 24 then notches forward, moving the whole printer 10 forward for it to print another line. In another arrangement (not illustrated) the traverse guide 62 can be movable relative to the ground wheel arrangement 24 in the direction of travel, so that an area may be printed while the ground wheel arrangement 24 is stationary, and then the ground wheel arrangement 24 moves forward by the length of the area printed so as to print an adjacent area of image.

Turning to FIG. 6, a smart communications module 22 includes processing circuitry 80 coupled to memory circuitry 82 e.g. volatile memory (V)/non-volatile memory (NV), such as such as flash and ROM.

The memory circuitry 82 may store programs executed by the processing circuitry 80, as well as data such as user interface resources, time-series data, credentials (e.g. cryptographic keys) and/or identifiers for the remote resource (which may for convenience be referred to as the cloud 100 or the edge 102(s) (e.g. URL, IP address). The memory circuitry 80 may also comprise access to machine learning algorithms stored in libraries to provide for an artificial intelligence equipped autonomous robot 10.

The module 22 may also comprise communication circuitry 84 including, for example, near field communicating (NFC), Bluetooth Low Energy (BLE), WiFi, ZigBee or cellular circuitry (e.g. 3G/4G/5G) for communicating with the remote resource(s)/device(s) e.g. over a wired or wireless communication link 86. For example, the module 22 may connect to remote resource(s)/device(s) within a local mesh network over BLE, which in turn may be connected to the internet via an ISP router.

The module 22 may also comprise input/output (I/O) circuitry 88 such as sensing circuitry to sense inputs (e.g. via sensors (not shown)) from the surrounding environment and/or to provide an output to a user e.g. using a buzzer or light emitting diode(s) (not shown). The module 22 may generate operational data based on the sensed inputs, whereby the operational data may be stored in memory 82. The I/O circuitry 88 may also comprise a user interface e.g. buttons (not shown) to allow the user to interact with the module 22.

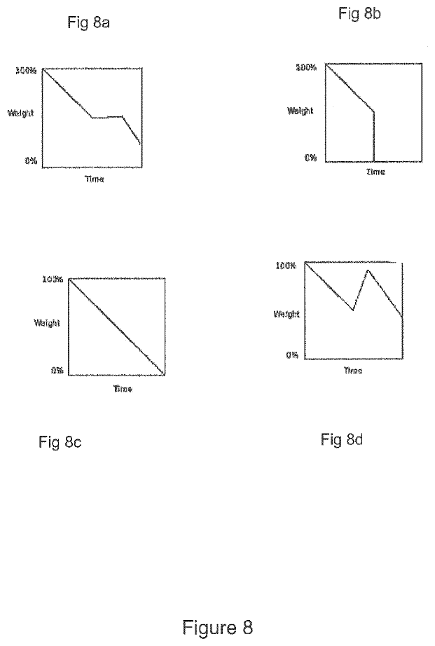

The module 22 may generate operational data based on the sensed inputs, such as that described in FIGS. 8 and 9 following. Although, the module 22 may comprise large scale processing devices, often the robot 10 will be constrained to battery power and so power may need to be managed and prioritised for movement of the robot 10 and actuation of the ground marking. Therefore, the module 22 may comprise a relatively small-scale data processing device having limited processing capabilities, which may be configured to perform only a limited set of tasks, such as generating operational data and pushing the operational data to a remote resource 100, 102 such as shown in FIG. 7.

For example, the module 22, may, for example, may include a tank management system, which generates operational data related to the registration of an input smart tank 14 comprising an ink bag 32 and the use of the ink R using data generated from the sensor 28 connected to a change in weight detected by the weight monitoring plate 14a, such as that shown with reference to FIGS. 8, 9 and 10 following.

Alternatively, the module 22 may, for example, comprise an embedded temperature sensor, which generates operational data based on the temperature of the surrounding environment, and may, for example be generated as a time series and fed, as best seen in FIG. 7, to a remote resource such as the cloud 100, the edge 102 such as a tablet used to control the robot 10 via communications link 86. The cloud 100 or the edge 102 may by return send instructions back to the robot 10 via a communications link 104 for the real-time adjustment of ground marking properties based on the data. In the present example, the cloud 100 and edge 102 may also communicate with each other via a communications link 108 and 110. This could be to update the instructions, send new instructions, initiate, or prevent the operation of the robot. The edge 202 may be between the communication between the robot 10 and the cloud 102. The robot laser 40 and position sensor 38 may communicate with the cloud 100 and/or the edge 102 to feedback into the real-time adjustment of ground marking properties based on the data.

FIG. 7 schematically shows an example of the robot 10 in communication with the cloud 100, the edge 102, such as remote resource, which may be a tablet, smartphone or laptop when the present techniques are applied. The edge 102 may be a tablet controlled by a user, such as a Groundsman located on site responsible for the upkeep of a pitch within a football or rugby stadium.

In the present example, it will be appreciated that the cloud 100 may comprise any suitable data processing device or embedded system which can be accessed from another platform such as a remote computer, content aggregator or cloud platform which receives data posted by the robot 10. Use of a cloud 100 means that the onboard memory 82 of the robot does not need to store everything, data e.g. machine learning libraries, print instructions and operation instructions, history data can be stored in the cloud 100.

In the present example, the robot 10 is configured to connect with the cloud 100 or the edge 102 to push data thereto, whereby, for the example, the robot 10 may be provided with the connectivity data (e.g. a location identifier (e.g. an address URL)) and credential data (e.g. a cryptographic key, certificate, a site secret) of the cloud 100 or the edge 102.

It will be appreciated that the robot 10 may connect to the cloud 100 or the edge 102, e.g. via the internet, using one or more nodes/routers in a network e.g. a mesh network. The robot 10 may connect to the nodes/routers using any suitable method, for example using Bluetooth Low Energy, ZigBee, NFC, WiFi.

A user wishing to access the data at the remote resource 100, 102 may do so subject to user privileges and subscription services using a client device 106 such as smartphone or tablet. In an illustrative example, the user may connect to the remote resource 100, 102 using a browser on the client device 106, whereby, for example, whereby clicking a link in the browser will cause the client device 106 to fetch the data from the remote resource 100, 102, which in the present example is a web-application 108.

The web-application 108 will start in the browser on client device 106 and cause the client device 106 to fetch data from the remote resource 100, 102. The web application will process the fetched data to provide a user interface to the user on the client device 106, whereby the user interface comprises the data presented in a human friendly form such as may be shown in FIG. 8.

In FIGS. 8a, 8b, 8c and 8d there is shown a series of Paint Tank Error Graphs, produced by the Tank Management System of the present invention.

The weighing plates of FIGS. 1-5 are used to monitor the weight (w) of the deposition materials in each tank onboard over time (t), as shall be described in FIG. 9.

One of the example uses is a ‘tamper protection’ (see description of FIG. 8d below), which provides a first pointer to a potential issue that might appear during normal (or in this case non-normal) usage of an ADR of the present invention.

FIG. 8a shows that if the paint tank weight (w) plateaus for a period of time (t) and then decreases, that a user may have drip fed the paint tank.

FIG. 8b shows that if the paint tank weight (w) drops suddenly, then the paint tank might have been damaged and is leaking.

FIG. 8c shows a normal weight to time ratio, which can be used as a ‘control’ graph for comparison to the other scenarios (a, b & d).

FIG. 8d shows that if the paint tank weight (w) decreases for a period of time (t) and then increases, without a removal and re-insertion event, that a user might have hand filled a paint cartridge with a paint that is not authorised. And in doing so, will have opened the packaging of the in bag and potentially caused damage.

Another purpose of the wireless transfer channel is to communicate real-time consumption data of deposition materials from the tank management system to a monitoring cloud database. Which then the data for forecasting demand, forecasting refill rates, forecasting automated refilling schedule intervals, remote robot or complete system performance diagnostics using ‘over the air’ methods. Eliminating the need for the operator to act removes the possibility for human error. The method may also include gathering performance diagnostics of the autonomous robot.

FIGS. 9a & 9b is a diagram showing a method for accurate tank management, according to a second embodiment of the present invention. There is shown the process steps, as shall be described following.

Step 1: The smart tank is inserted into a slot in the frame of the autonomous deposition machine by a user.

Step 2: The presence of an RFID tag is detected by the autonomous deposition machine.

Step 3: The RFID tag data is read into the processor of the autonomous deposition machine (see FIGS. 6 & 7 for further details).

Step 4: The central database is checked for the tank data. This is done through either a locally cached version of the central database or by a connection to the cloud (see FIGS. 6 & 7 for further details).

Step 5: Is the tank registered in the database? This step is a check of the authenticity of the smart tank. If it is, go to step S6. If not, go to step S7.

Step 6. Do the database registered smart tank contents match the requirements of the deposition job? This is step is to check that the user has placed the correct deposition materials for the correct job in the autonomous deposition machine. If so, move to step S9. If not, got to Step S7.

Step 7. Notify user the smart tank is not valid for use with this autonomous deposition machine.

Step 8: The user must replace the tank with the correct one.

Step 9: The smart tank inserted is valid for use with the autonomous deposition machine. Go to step S10 of FIG. 9b.

### End of Process of FIG. 9a

### Begin Process of FIG. 9b

Step 10: Get initial tank weight value and total weight from the central database.

Step 11: Get deposition data from the central database for the autonomous deposition machine model and deposition medium combination. In the central database there are stored values for the flowrate of each incremental pressure value, paint type, machine setup combination. The autonomous deposition machine therefore fetches the specific value that it needs (machine configuration X, paint Y, pressure Z) for flowrate. The data comes from empirical means and is historically collected data on paint usage at the configurations and ascertained the flowrate values. The autonomous deposition machine then uses this value to calculate estimate paint use (see step S12).

Step 12: Estimate current weight of tank based on the total weight used from the tank subtracted from the initial weight.

Step S13: Is the estimated tank weight below the defined empty tank weight? If yes, go to step S14. If no, go to step S15.

Step 14: Register the tank as empty and notify the user that the tank required replacement. Got to step S8 of FIG. 9a.

Step 15: Update the user interface with estimated tank weight.

Step 16: Wait for an instruction for a deposition action with a tank, such as a print instruction.

Step 17. Carry out deposition action (ie instruction) with the tank on-board the autonomous deposition machine.

Step 18: Calculate volume used in the deposition action using the deposition flowrate data, (as described in Step S11).

Step 19: Update value in central database for total volume used from the tank.

### Process End

The database may comprise a revocation list of packaging or materials that are no longer supported, out of date or out of contract. In which case an error message may be displayed to the user.

The database may contain a list of verified marking materials authorised for use and may in return grant permission for the robot 10 to accept the material and may, depending in the type of material, make mechanical or software adjustments. For example, a nozzle 42 height may be adjusted to spray fertilizer in a different way to that nozzle 42 arrangement for high resolution image printing.

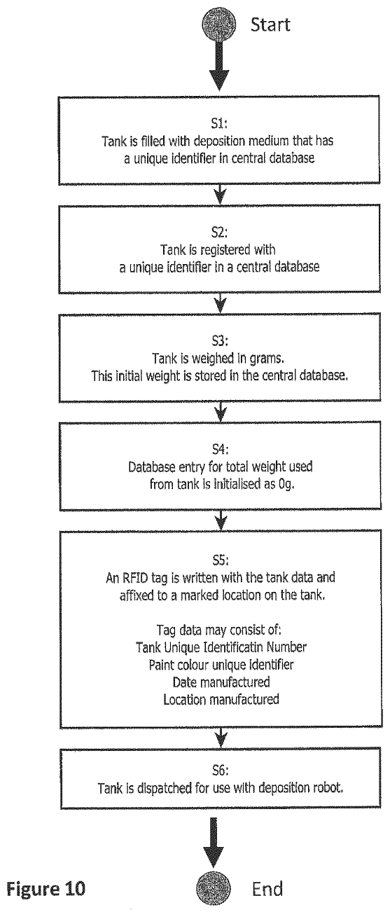

FIG. 10 is a process diagram showing the registration process of a smart tank, according to one embodiment of the present invention. There is shown the following process steps:

### Process Start

S1: The smart tank is filled with a deposition medium, such as a paint or herbicide, that has a unique Identifier (ID), in a central database (not shown).

S2: The smart tank is registered with a unique Identifier (ID), in a central database (not shown).

S3: The tank is then weighed in grams and the initial weight is stored in the central database.

S4: The database entry for the total weight used from the tank is initialised as 0 g.

S5: An RFID tag is written with the smart tank data and affixed to a marked location on the smart tank. The tag data may consist of the Tank's Unique ID; the paint or material identifier, such as paint colour. The date the material was manufactured, and/or the location where it was manufactured. Other data such as batch numbers, expiry dates etc can also be encoded.

S6: The tank is ready for dispatch and to be used in a deposition robot of the present invention.

### End of Process

The robots, systems, and methods described herein can be adapted for use with different types of surface or substrate, depending on the purpose and surface for it to be used with.

The robots, systems, and methods described herein can be used to deposit material on multiple different substrates, surfaces, or the ground. For example, these could be, grass, turf, AstroTurf, artificial turf, synthetic turf, plastic turf, concrete, polished concrete, tarmac or tarmacadam ground surfaces, dirt, gravel, wood chip, carpeting, rubber, roads, asphalt, brick, sand, beaches, mud, clay wood, decking, tiling, stone, rock and rock formations of varying types of rock or stone, snow, ice, ice rinks, artificial snow, polymer surfaces such as polyurethane, plastic, glass and leather.

The robots, systems, and methods described herein can be adapted for use with different surfaces, such as sports (e.g. football, cricket, racing, rugby, hockey, ice hockey, skiing, shooting) pitches, ski slopes, dry ski slopes, race courses, gymnasiums, indoor sports venues and running tracks.

In an exemplary embodiments, the robots, systems, and methods described herein may be used for printing or painting on a substrate or on the ground. This can be to print or paint, with inks or paint, logos, information, advertising or messages on the ground. When large images are printed, they are printed with adjacent dots or pixels so that when viewed from above or a suitable distance from afar (e.g. from the stand in a stadium or from a television view) the images are easily determined. Print instructions can be determined so that when an image, e.g. a logo is printed, they can be visible from stadium stand or by a viewer watching an event at home on television. The robots, systems, and methods described herein offer an improvement to printing methods for advertising purposes.

In examples, the material for deposition is a herbicide, pesticide, insecticide, plant growth aid, water or marking material, optionally wherein the marking material is a paint, ink, coloured material, powder. The robots and method of using such robots described herein may also carry out multiple functions at the same time. For example, bags may contain paint for deposition to mark a logo on a pitch but may also contain fertiliser to fertilise the pitch.

1. A tank management system for an autonomous ground marking robot, the tank management system comprising:
an input operable to receive sensor data from one or more sensors coupled to at least one receptacle, the receptacle operable to hold a deposition material;
a processor for processing said sensor data to obtain user diagnostics;
an output for outputting said user diagnostics.

2. A tank management system according to claim 1, wherein the sensor is a temperature sensor.

3. A tank management system according to claim 1, wherein the sensor is a weight measuring plate.

4. A tank management system according to claim 1, wherein the sensor is a PIR sensor.

5. A tank management system according to claim 1, wherein the sensor is an RFID reader.

6. A tank management system according to claim 1, the system further comprising processing said sensor data to obtain system diagnostics, and outputting said system diagnostics.

7. A tank management system according to claim 1, wherein the user diagnostics is tamper data.

8. A tank management system according to claim 1, wherein the coupling is wired.

9. A tank management system according to claim 1, wherein the coupling is wireless.

10. A tank management system according to claim 1, wherein the sensor data is used for forecasting demand, forecasting refill rates, forecasting automated refilling schedule intervals, remote robot and/or complete system performance.

11. An autonomous ground marking robot comprising:
at least one receptacle to hold a deposition material;
at least one deposition arrangement;
a locomotion arrangement; and
the tank management system according to claim 1.

12. A robot as claimed in claim 11, wherein the flexible bag or the tank is supported by a weight monitoring device or volume monitoring system.

13. A robot as claimed in claim 11, comprising one or more load sensors provided to measure the weight of the flexible bag or flexible bag and tank.

14. A robot as claimed in claim 11, wherein the robot comprises an accelerometer to measure tilt and computation means are provided to determine weight of the flexible bag or flexible bag and tank using one or more load sensors measurements whilst accounting for tilt.

15. A robot as claimed in claim 11, wherein the flexible bag or the tank are held in a frame housed with the robot.

16. A robot as claimed in claim 11, wherein the robot comprises an on-board control system.

17. A robot as claimed in claim 16, wherein the robot comprises an onboard control system having a communications link to the weight monitoring device.

18. A robot as claimed in claim 17, wherein, when the robot is in use and depositing material on the ground, the onboard control system is configured to periodically gather weight data from the weight monitoring device.

19. A robot as claimed in claim 18, wherein the onboard control system is configured to transmit weight data to a remote resource, such as a cloud server, or an edge device optionally a tablet or smartphone.

20. A robot as claimed in claim 11, wherein the material for deposition is a herbicide, pesticide, insecticide, plant growth aid, water or marking material, optionally wherein the marking material is a paint, ink, coloured material, powder.

21. A method of depositing material using the robot of claim 11, the method comprising:
a user sending deposition instructions to the autonomous robot; and
the autonomous robot depositing material according to the deposition instructions.

22. A method of calculating the usage weight of a tank of deposition material when in use in an autonomous deposition robot, the method comprising the steps of
obtaining initial tank weight data;
obtaining tank and machine deposition flow rate data values for the tank and autonomous deposition robot;
receiving at least one instruction for a deposition;
carrying out the deposition in accordance with the at least one instruction;
calculating the weight used in the deposition using the deposition flow rate data values;
calculating the total weight of deposition material used by adding the weight used in the deposition to the current total weight usage;
outputting the total weight of deposition material used; and
estimating the new current weight of the tank based on the newly calculated total weight used from the tank subtracted from the initial weight.

23. A method as claimed in claim 21, wherein the user sends deposition instructions to the autonomous robot via a cloud server or device, or an edge server or device.

24. A method as claimed in claim 21, wherein the material to be deposited is marking material, paint or ink, and the deposition instructions are printing instructions.

25. A tank management system for an autonomous ground marking robot, the tank management system operable to carry out the method steps of claim 21.
